(19) United States
(12) Patent Application Publication
(10) Pub. No.: US 2009/0276286 A1
(43) Pub. Date: Nov. 5, 2009

(54) MEASURING PRODUCT CONSUMABILITY

(75) Inventors: Lucio Bortolotti, Rome (IT); Agostino Colussi, Rome (IT); Virginia D. Hill, Raleigh, NC (US); Peter H. Sohn, Chelmsford, MA (US); Scott A. Will, Wake Forest, NC (US)

Correspondence Address: IBM CORPORATION;C/O: RADER, FISHMAN & GRAUER PLLC, 10653 S. RIVER FRONT PKWY., STE. 150, SOUTH JORDAN, UT, 84095, US

(73) Assignee: INTERNATIONAL BUSINESS MACHINES CORPORATION, Armonk, NY (US)

(21) Appl. No.: 12/114,728

(22) Filed: May 2, 2008

(51) Int. Cl. G06Q 30/00

(52) U.S. Cl. 705/10

(57) ABSTRACT

Product consumability can be measured by recording customer interaction with customer support mechanisms and mapping the resulting data into consumability characteristics. The consumability characteristics correspond to specific customer experiences with various features and processes throughout the product lifecycle. Through an examination of data mapped into the various consumability characteristics, the vendor or manufacturer can focus on improving features or processes associated with the product.

### BACKGROUND OF THE INVENTION

Customers buy and use a variety of products, services, and systems from vendors or manufacturers. The commercial success of the product, service or system depends on its consumability characteristics. The consumability characteristics are elements associated with the product that shape the customer's experience with the product throughout the product lifecycle. For example, the customer's experiences in finding, purchasing, installing, operating, and maintaining a product are influenced by the consumability characteristics of the product. The consumability characteristics associated with the operation of a product may include the ability of the product to meet the customer needs, efficiency of the product, and the ease of use of the product. For a company to improve its product by increasing the product's consumability, the company must first have a quantitative and actionable understanding of the consumability areas which need improvement. Particularly in complex products, such as software suites and computer systems, obtaining a quantitative and actionable understanding of product areas which need improvement can be difficult.

### BRIEF SUMMARY OF THE INVENTION

A method of analyzing the consumability of a product, service, or system includes obtaining customer support records; mapping the customer support records into consumability categories; and generating a description of a distribution of the customer support records within the consumability categories. A computer program product for analyzing a product's consumability includes computer usable program code which aggregates customer service records that contain customer service data; the computer usable program code then maps the customer service records into consumability characteristics and generates a description of a distribution of the customer service records among the plurality of consumability characteristics.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram of one illustrative process for utilizing customer support data to quantify consumability of a product, according to one exemplary embodiment of principles described herein.

FIG. 2 is a diagram of an illustrative customer support record containing customer support data, according to one exemplary embodiment of principles described herein.

FIG. 3 is a diagram of an illustrative mapping from customer support data to market drivers and consumability attributes, according to one exemplary embodiment of principles described herein.

FIG. 4 is a diagram showing an illustrative chart for quantifying customer support data according to consumability attributes, according to one exemplary embodiment of principles described herein.

FIG. 5 is a diagram of an illustrative mapping from consumability attributes to consumability criteria, according to one exemplary embodiment of principles described herein.

FIG. 6 is a diagram showing an illustrative chart for quantifying customer support data according to consumability criteria, according to one exemplary embodiment of principles described herein.

FIG. 7 is a flowchart showing one illustrative method for using customer support data to quantify product consumability, according to one exemplary embodiment of principles described herein.

Throughout the drawings, identical reference numbers designate similar, but not necessarily identical, elements.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks

As noted above, customers buy and use a variety of products. Many of these products are supported by the vendor or manufacturer following the purchase. In such cases, when a customer has an issue with a supported product, the customer can access any one of a variety of support mechanisms provided by the vendor or manufacturer. The support mechanisms may include online diagnostic tools, literature provided with the product, a product support telephone hotline, an online chat with a customer representative, e-mail access to customer representatives, or an on-site technician. As the customer interacts with the support mechanisms, a customer support record can be created, which records a variety of information such as the identity of the customer, the type of products they are using, the event which prompted them to contact customer support, the underlying problem with the product, the resolution of the problem, etc.

For a company to improve a product, for example, by eliminating flaws, improving ease of use, increasing efficient or productivity, and/or reducing support costs, the company must first have a quantitative and actionable understanding of the aspects of the product that need improvement. Particularly in complex products, such as software suites and computer systems, obtaining a quantitative and actionable understanding of aspects or areas of the product that need improvement can be difficult.

As used in the specification and appended claims, the term “product” refers broadly to goods, services, systems, support, or other tangible or intangible goods or materials that are offered by a manufacturer or vendor to a customer or consumer. The term “consumability” will be used throughout the specification and appended claims to refer to how well the product suits the purchaser, for example, how easy the product is to use, at various stages throughout the product lifecycle. The product lifecycle may include stages such as the selection, purchase, installation, operation, maintenance, and upgrading of the product.

If a company wants to improve the consumability of their products, it can be helpful to first measure the product consumability of various components, procedures, or features of the product. Product components, procedures or features that are inefficient, difficult to use, or prone to failure can then be targeted for improvement.

A variety of methods could be used to evaluate various aspects of product consumability, including in-house testing and customer surveys. In-house testing can be useful in some areas, but it may be expensive and difficult to simulate the systems and operator actions of the entire consumer base. Surveys can provide some indication that a product is easy or difficult to use. However, surveys can be expensive and may lack the detail necessary to pinpoint problem aspects of or areas within the product.

Support calls can be a valuable and direct source of information about the consumability of the product. When a customer calls technical support, the representative will record information about the customer's problem, such as what the customer was doing when the problem occurred, what product they were using, and what happened that prompted them to call customer support. Consequently support records are a valuable, but often untapped, resource for quantitatively identifying the current consumability of the product in question and, consequently, potential consumability improvements that could be made to the product. A method is needed to derive quantitative and actionable understanding of the consumability of a product from support records.

As used herein an in the appended claims, a hierarchy of consumability characteristics are defined within which the consumability of a product can be evaluated. Consequently, the term “consumability characteristics” will be used to describe the entire universe of a product's characteristics that bear on its consumability. Within “consumability characteristics,” we may define a number of market drivers. “Market drivers” are major consumability characteristics that tend to have an impact on the market for the product. Examples of market drivers may include a positive first use of the product, that the product meets the consumer's needs, that the product enhances consumer productivity, etc. Within each market driver, we may define specific “consumability attributes” of the product that relate to specific market drivers. Finally, within each consumability attribute, we may define specific “consumability criteria.” Consumability criteria are the most detailed aspects of consumability and may correlated to different stages in the lifecycle of the product. With this hierarchy and the defined taxonomy in place, the following describes a method to derive quantitative and actionable understanding of the consumability of a product from support records.

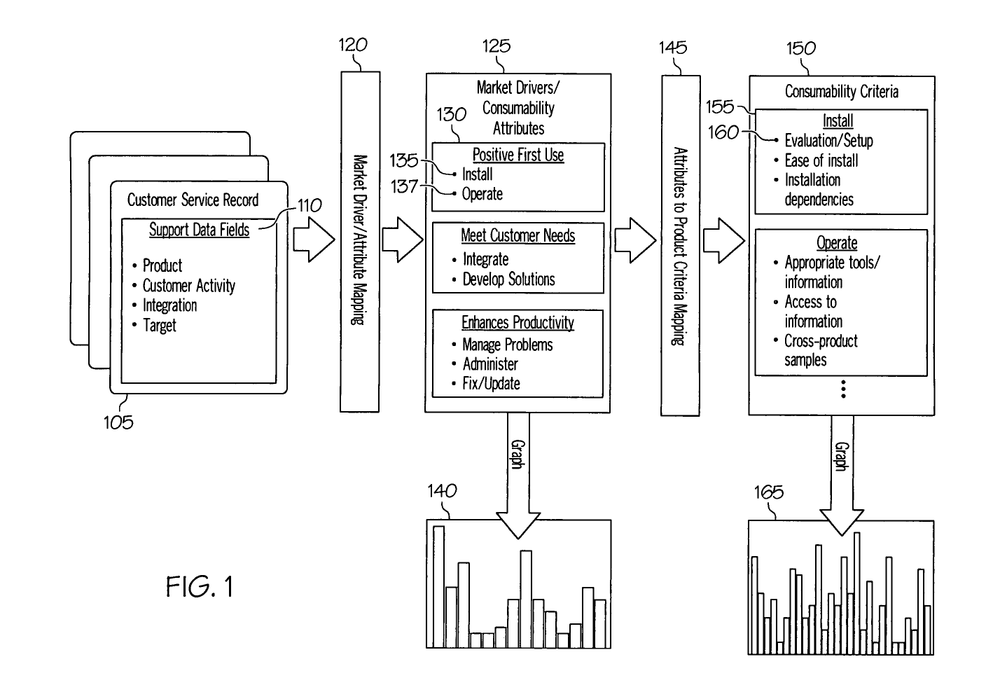

FIG. 1 is a diagram of one illustrative process for utilizing customer support data to quantify consumability of a product. In this process, customer service records (105) are gathered and mapped (120) to market drivers and consumability attributes (125). The consumability attributes may be visually represented on a graph (140). The consumability attributes are then further mapped (145) into consumability criteria (150), which can then be represented in a variety of ways including generating a graph (165). Each of the elements of FIG. 1 will be described in further detail below.

The customer service records (105) are records generated during the interaction of the customer with the support provider. By way of example and not limitation, the customer service record (105) could be generated as a result of customer interaction with an online diagnostic tool, online chat or e-mail interaction with a support person, or though a support call to a technical support person. During this interaction, the customer may be asked to provide information which is recorded in support data fields (110). These fields including, for example, product identifying information, the activity the customer was performing when the problem occurred, the situation in which the product was being used, that nature of the problem prompting the need for product support and other information necessary to appropriately address the customer's concern. According to one exemplary embodiment, this information is entered into support data fields (110). A variety of other information may be included in the customer service records (105). For example, the ultimate resolution to the problem may also be included in the customer service records (105).

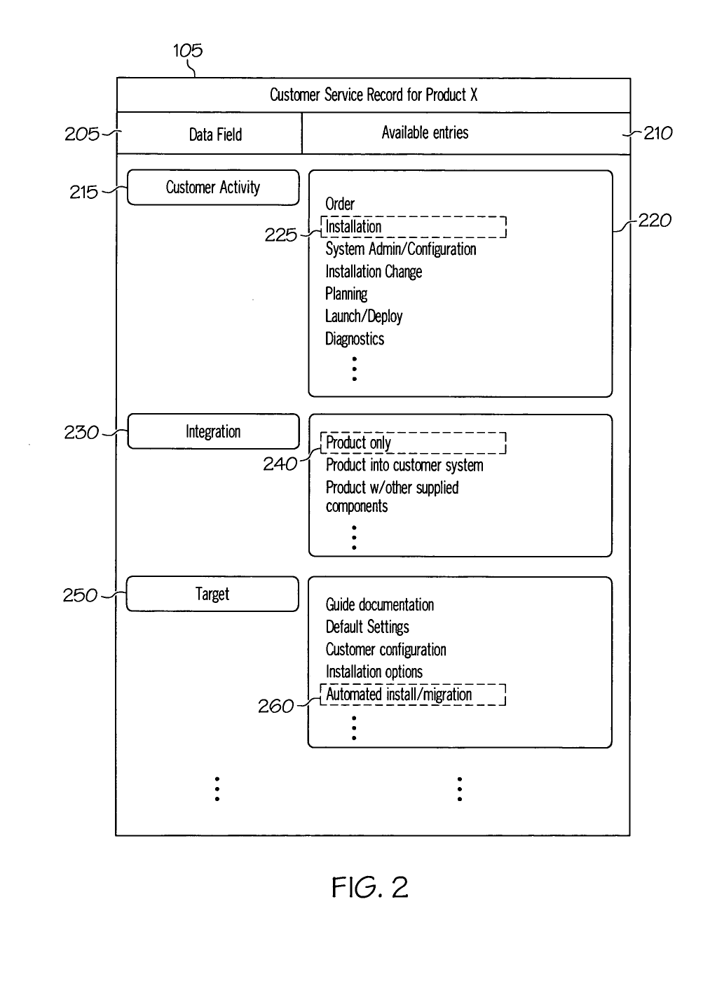

There are a number of ways in which the customer service record may be created. The creation of one exemplary embodiment of a customer service record is further described in FIG. 2 and its associated text. By way of example and not limitation, during the interaction with the customer, a technical support person may use a software interface to enter data into the data support fields (110). To enter data into a particular data field (110), the technical support person may enter descriptive text into an input field or may use some other data input mechanism such as choosing from a variety of options listed on a pull-down menu. Additionally, subsequent menu items may depend on which option the technical support person had previously chosen. Any type of data entry mechanism may be used. The support person may type information directly into data field, select a radio button indicating the desired option, or some of the fields may be automatically filled by obtaining information from external databases.

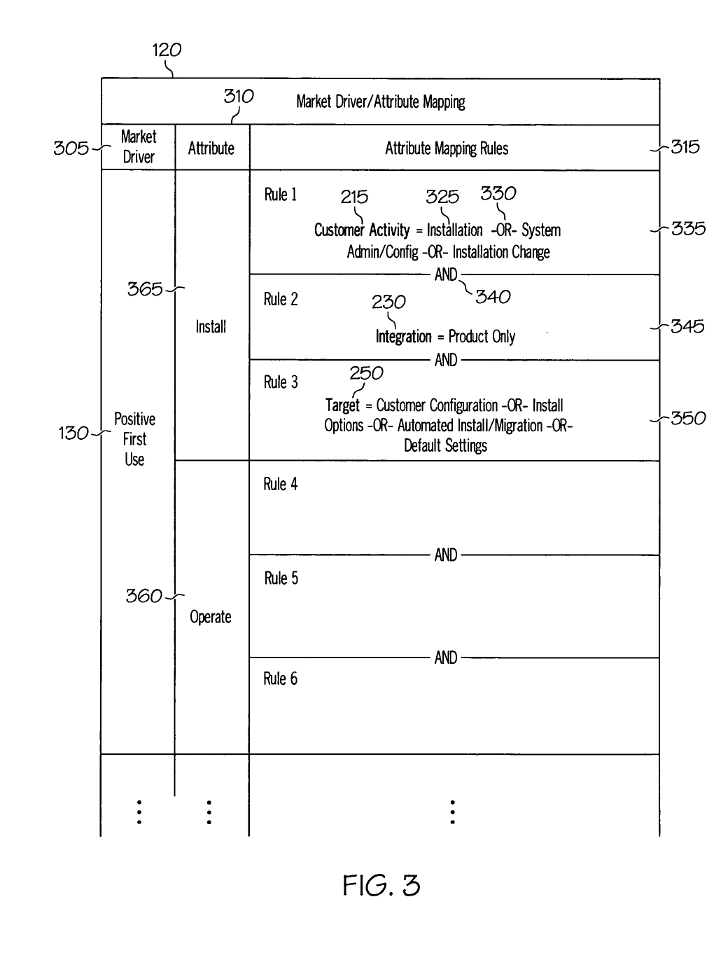

Customer service records (105) for a particular product are aggregated and passed through a market drivers/attribute mapping (120). The market drivers/attribute mapping (120) is further described in FIG. 3 and accompanying text. The market driver/attribute mapping (120) categorizes each customer service record (105) according to a particular market driver and consumability attribute that is fundamental to the customer concern.

Market drivers describe various areas within the consumer experience throughout the lifecycle of the product. By way of example and not limitation, a first market driver (130) maybe a “positive first use” of the product. A “positive first use” experience by the customer can drive market value or demand for the product because a “positive first use” experience inspires confidence in the product from the beginning. A “positive first use” experience allows the customer to derive value from their investment in the product quickly. For example, in the case of a software package, the product is installed and operational within the customer system rapidly, which leads to buy in from users and smoothes transition and learning periods. Other market drivers, such as “meets customer needs” and “enhances customer productivity” similarly define areas of the customer experience that influence the market and success of the product.

Each market driver is divided into a number of consumability attributes (135). Consumability attributes (135) describe specific customer interactions with the product. A number of consumability attributes represent the range of customer interactions with the product which are related to that market driver. By way of example and not limitation, the “Install” attribute (135) and the “Operate” attribute (137) combine with additional attributes to form the “Positive first use” market driver (130). As will be appreciated by those of skill in the art, the market drivers and attributes are merely illustrative of possible categories which could be selected to describe a customer's experience with the product and the underlying product features.

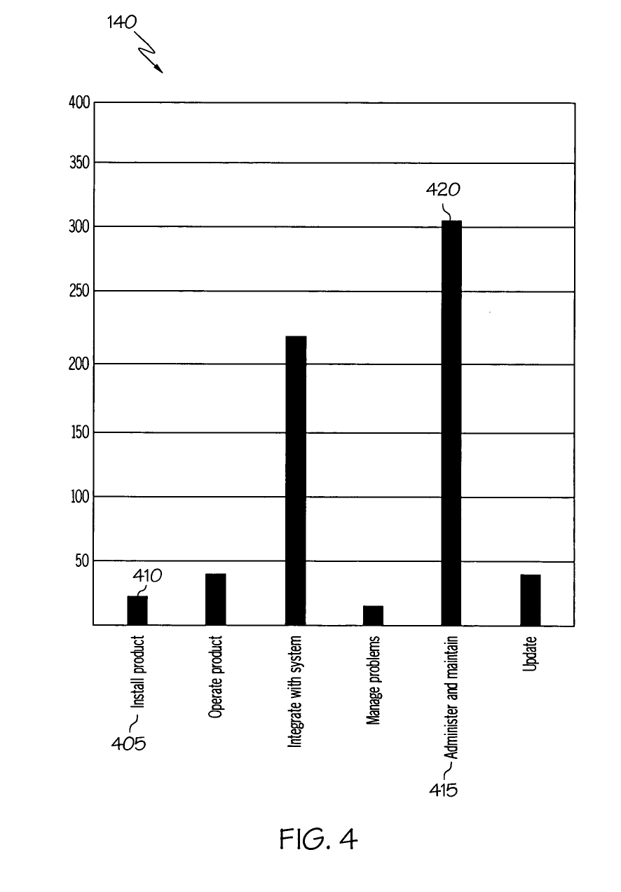

According to one exemplary embodiment, the market driver/attribute mapping (120) assigns each customer service record (105) to a specific attribute (135) within a market driver category (130). The distribution of the customer service records (105) within the market drivers/attributes (125) categories can be represented by a graph (140). The graph (140) is further illustrated and discussed with respect to FIG. 4. The graph (140) allows a visual comparison of the numbers of support requests received within any particular market driver/attribute category. This visual representation provides a quantitative perspective on the cost of providing support to the customers throughout the lifecycle of the product and allows decision-makers to focus preventative/improvement efforts in appropriate areas.

To obtain further insight into the specific weaknesses/strengths of a product, system or organization, the customer service records (105) within a particular attribute may be further mapped to consumability criteria (150) by an attribute to consumability criteria mapping (145). The consumability criteria represent specific sub-categories of the consumer experience which can be directly addressed to improve the consumer experience with a particular consumability attribute. By way of example and not limitation, the “install” attribute (155) may contain a number of consumability criteria (160). These consumability criteria may include “an evaluation/setup,” “ease of installation,” “installation dependencies,” and other criteria. The consumability criterion “evaluation/setup” (160) may refer to the first time a consumer installed and configured the product to evaluate whether it met the consumer's needs. The “ease of installation” consumability criterion refers to the customer experience in installing the product into the customer's system for the first time. The “installation dependencies” consumability criterion may refer to the consumer experience in understanding the prerequisites necessary to select and correctly install the product within the consumer system.

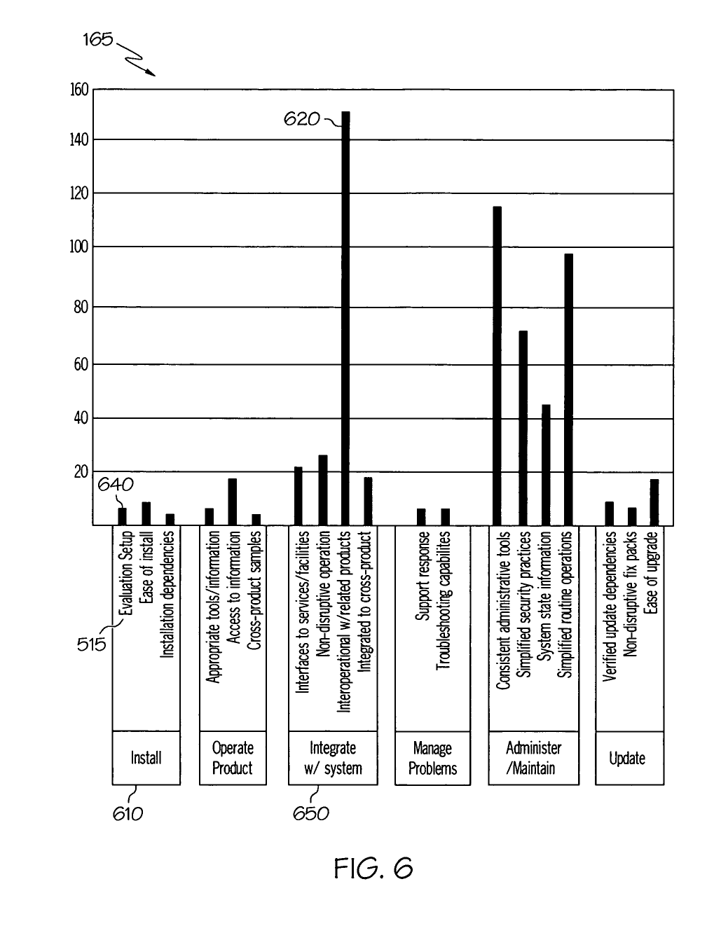

The combination of these consumability criteria (160) directly contribute to the consumers positive or negative experience in installing the product. By further dividing the consumability attribute of “installing” the product into these consumability criteria, specific functionality and design within the product can be pinpointed for improvement. A visual representation of the consumability criteria (160) can be used to inform decision-makers about specific and actionable product features which can be targeted in preventative and improvement efforts. A second graph (165) is one method of visually representing consumer data within the consumability criteria. The second graph (165) is further discussed and illustrated in FIG. 6.

FIG. 2 is a diagram of an illustrative service record (105) for a Product X. According to one exemplary embodiment, the customer service record (105) is filled out by the customer service person during the interaction with the customer. A number of data fields (205) are available including a “customer activity” data field (215), an “integration” data field (230), and a target data field (250). For each data field (205) there is a list of available entries (210). According to one exemplary embodiment, the available entries (220) for the customer activity data field (215) include such options as “installation,” “system admin/configuration,” “installation change,” and others. In the illustration of FIG. 2, the customer service person has selected “installation” as the customer activity which prompted the customer to call for customer support. The customer service person's selection is indicated by a first dashed box (225). Similarly, as indicated by the second dashed box (240), the customer service person has selected “product only” as the pertinent entry for the “integration” data field (230). Other options might include “product into customer system,” “product with other supplied components,” and others. A third dashed box (260) indicates that the customer service person has selected “automated install/migration” as the relevant entry for the “target” data field (250). Other options might include “guide documentation,” “default settings,” “customer configuration,” “installation options,” and others.

In one exemplary embodiment, the customer service record is entered through a software interface. The software interface is configured such that each customer service record follows an exclusive problem classification taxonomy which requires that each customer service record explicitly identify one and only one problem. In alternative embodiments, multiple interrelated problems can be recorded on a single customer service record (105) by making appropriate notations within the service record (105). The exclusive problem classification taxonomy can also be used in this situation by segmenting the individual problems, while maintaining the interrelationship data between the problems.

The customer service record (105) is merely one illustrative example of a customer service record. Customer service records may take a variety of forms and need not follow a strict taxonomy or be software-based. By way of example and not limitation, historical service records could be aggregated and then translated into a given taxonomy or organizational structure prior to mapping the customer service record into market driver/consumability attributes for the given product.

FIG. 3 is a diagram of an illustrative mapping (120) of customer support records (105, FIG. 2) into market driver categories (305) and consumability attribute sub-categories (310). A number of attribute mapping rules (315) are applied to specific support data fields (205; FIG. 2) within a customer service record (105; FIG. 2).

By way of example and not limitation, the attribute mapping rules (315) for the “install” consumability attribute (365) may include a first rule (335), a second rule (345), and a third rule (350). These rules (335, 345, 350) may have either positive or negative subparts; may be exclusive or inclusive rules; and may be combined by a number of logical operators (330, 340). Customer support records (105, FIG. 2) which contain data fields (205, FIG. 2) that meet every condition within the combination of rules for a given attribute (310) are classified within that particular market driver and consumability attribute.

By way of example and not limitation, the customer service record (105; FIG. 2) shown in FIG. 2 could be classified according to the attribute mapping rules (315) contained within the market driver/attribute mapping (120). The first rule (335) is satisfied if the “customer activity” data field (215) contains one of the entries “installation” (325) or “system admin/config” or “installation change.” A variety of Boolean operators (330, 340) could be used to join rule elements or to combine multiple rules. A second rule (345) states that the “integration” data field (230) must contain the entry “product only.” A third rule (350) states that the “target” data field (250) must contain the entry “customer configuration” or “installation options” or “automated install/migration” or “default settings.” If the first rule (335), the second rule (345), and the third rule (350) are all satisfied, the customer service record (105, FIG. 2) will be classified within the “positive first use” market driver (130) and the “install” attribute (365). In FIG. 2, the “customer activity” data field (215, FIG. 2) has an entry of “installation” (225, FIG. 2), an “integration” data field (230, FIG. 2) with a “product only” (240, FIG. 2) entry, and a “target” data field (250, FIG. 2) with an “automated install/migration” entry (260, FIG. 2). Consequently, the customer service record (105, FIG. 2) satisfies the three rules described above and will be categorized within the “positive first use” market driver (130) and the “install” attribute (365).

According to one exemplary embodiment, where the customer service record (105, FIG. 1) follows an orthogonal or exclusive problem classification taxonomy, each customer service record is mapped into one and only one market driver/consumability attribute category. In alternative embodiments, a single service record could be mapped into multiple categories.

FIG. 4 is a diagram showing an illustrative graph (140) for quantifying customer support data according to consumability attributes. After gathering and mapping a number of customer service records related to a product, the number of customer service records which fall into the individual consumability attributes can be graphed. In the illustrative graph (140), the consumability attributes are listed across the horizontal axis of the graph (140). The vertical axis represents the number of customer service records that fall into each of the consumability attributes.

For example, about 25 customer service records mapped into the “install” consumability attribute (405), as shown by a first bar (410). In this example, the consumability attribute with the largest number of customer service records is the “administer and maintain” consumability attribute (415). A second bar (420) associated with the “administer and maintain” consumability attribute (115) indicates that slightly more than 300 customer service records addressed a customer problem or issue with administering and maintaining the product.

According to one exemplary embodiment, the results of mapping customer service records into consumability attributes could be weighted by a number of factors to give perspective to the results. By way of example and not limitation, if the chart in FIG. 4 represents a mapping of customer service records for Product X, weighting factors could account for the number of new versions of Product X that had been sold during the time period compared to the quantity of product X that is currently installed and in use. If the majority of the service records regarding Product X during the time period were for instances of Product X already installed and in use, it would be expected that a correspondingly small number of customer service records would fall into the “install” attribute, while a correspondingly larger number may fall into the “administer and maintain” attribute (415). By using weighting factors to adjust for this or other variations, additional perspective can be gained on the overall reliability and costs associated with Product X throughout its lifecycle.

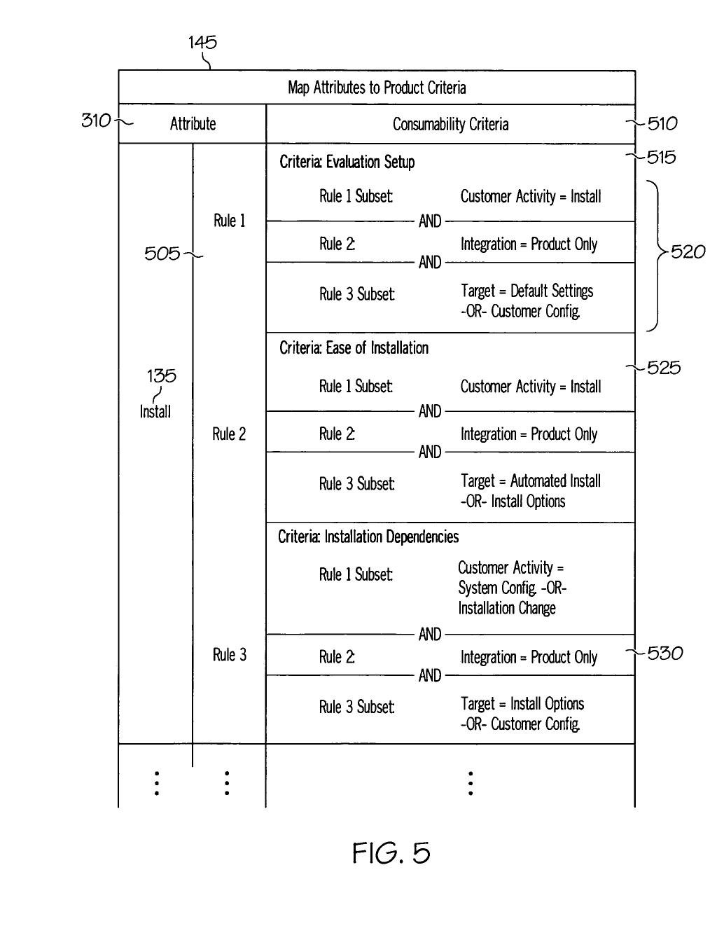

FIG. 5 is a diagram of an illustrative mapping (145) from consumability attributes (310) to consumability criteria (510). The attributes (310) are mapped into consumability criteria (510) by applying a subset of the rules which define the given attribute. As mentioned above, the consumability criteria represent specific sub-categories of the consumer experience that can be directly addressed to improve the consumer experience within a particular consumability attribute. By further classifying the customer service reports (105, FIG. 1) that fall into the various attributes (310), specific customer experiences within the attribute can be explored. By way of example and not limitation by, a rules subset (520) channels a portion of the customer service records within the “install” attribute (135) into the “evaluation setup” criterion (515). By classifying the customer service reports (105, FIG. 1) that fall into the “install” attribute (135) into narrower criteria (515, 525, 530), additional perspective can be gained about customer experiences as they install the product. In this illustrative embodiment, there are three criteria (515, 525, 530) within the install attribute (135): an “evaluation set up” criterion (515), an “ease of installation” criterion (525), and an “installation dependencies” criterion (530). The “evaluation set up” criterion (515) may specifically address the customer experience in installing and configuring the product to evaluate whether the installation routine meets the consumer's needs. The “ease of installation” criterion (525) may specifically address the experience of the customer during the installation of the product for use within the customer's organization. The “installation dependencies” criterion (530) may address the ability of the customer to determine the prerequisite conditions that are necessary for installing the product.

Consumability criteria are defined by a narrower subset of the rules that define the parent attribute. By way of example and not limitation, the “install” attribute (135) is defined by a set of three rules (505) that were described in greater detail above in connection with FIG. 3. The rule subset (520) for the “evaluation set up” criterion (515) utilizes a subset of the first rule, and identical second rule, and a subset of the third rule. Consequently, only a portion of customer service records that fall into the install” attribute (135) will fall into the “evaluation set up” criterion (515).

By way of example and not limitation, the “evaluation set up” criterion (515) consists of a subset of a first rule that requires that the “customer activity” data field (215, FIG. 2) have a value of “installation” (225, FIG. 2). Consequently, customer service records (105, FIG. 2) within the “install” attribute (135) which contain “customer activity” data fields with the value of “system configuration” or installation change” will not fall within the “evaluation set up” criterion (515). The second rule is identical in scope to the rule used to define the “install” attribute (135). The last rule within the “evaluation set up” criterion (515) is a subset of the third “installation” attribute rule and requires that the “target” data field contain a value of “default settings” or “customer configuration.”

FIG. 6 is a diagram showing an illustrative graph (165) which visually represents the number of customer support records (105, FIG. 2) that fall into each consumability criterion, grouped here by attribute. The horizontal axis of the graph (165) lists the various consumability attributes and the consumability criteria that are within each attribute. The vertical axis represents the number of consumer service reports that fall into each of the consumability criteria.

For example, the “install” attribute (610) consists of a number of consumability criteria including the “evaluation set up” criterion (515). As shown in a first bar (640), approximately 7 of the 20 total customer service reports (105, FIG. 1) in the “install” attribute (610) fall within the “evaluation set up” criterion (515). The remainder falls into the “ease of installation” criterion and the “installation dependencies” criterion.

According to the illustrative chart in FIG. 6, the “interoperational w/related products” consumability criterion within the “integrate with system” attribute (650) contains the greatest number of customer support records. As indicated by a second bar (620), approximately 150 customer support records were mapped into the “interoperational w/related products” consumability criterion.

By mapping the consumability attributes into various consumability criteria, specific elements of the customer experience can be more closely examined. Additionally, because each customer service report requires time and resources to complete, the number of consumability reports directly correlates to the cost to the organization of the particular flaw or weakness in the product which triggered the customer to request additional support. The mapping of customer support records into consumability criteria provides concrete and actionable information which can be used to focus improvement, prevention, and remedial efforts.

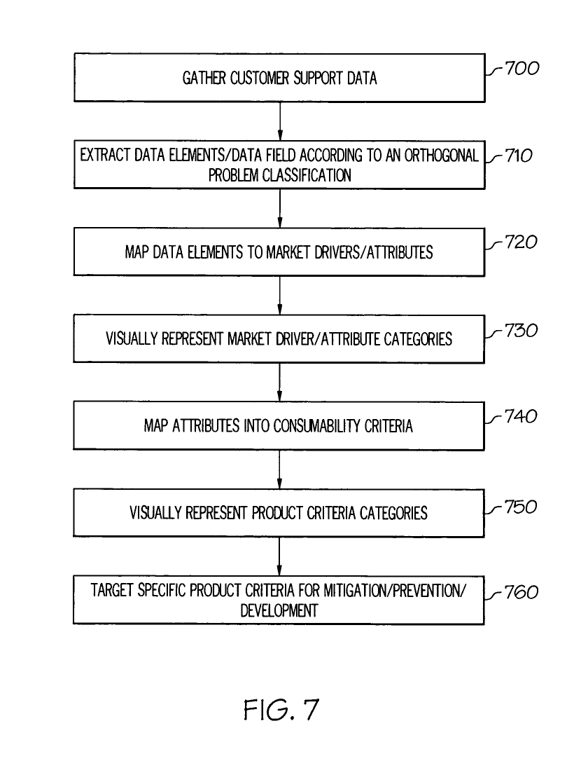

FIG. 7 is a flowchart showing one illustrative method for using customer support data to quantify a product's consumability. In a first step, customer support data is gathered for a particular product or system (step 700). Alternatively, if a company wide evaluation is desirable, customer support data related to a number of products could be aggregated. A companywide evaluation could give perspective on strengths or weaknesses of the company or the company's product offering as a whole. By way of example and not limitation, if a company develops, distributes, and supports a variety of software packages, a companywide evaluation could point to weaknesses within the internal processes of the organization as a whole.

In some circumstances, the customer support data may be formatted or extracted into various data fields. According to one exemplary embodiment, the data elements/data fields are formatted into an exclusive problem classification taxonomy (step 710). The data elements are then mapped using rules into various market driver/consumability attributes (step 720). The mapping or post-processing of the mapped data may include a number of weighted leading factors to compensate for various external or internal influences which may skew the results. The various market drivers/consumability attributes can then be visually represented to allow decision-makers to examine the data for areas amendable to potential improvement, cost management, or other goals (step 730).

The customer support data within each market drivers/attribute can then be further categorized by mapping the customer support data and consumability criteria (step 740). In some circumstances, the consumability criteria may provide a more focused target for improvement efforts. By way of example and not limitation, if a large portion of the customer support data indicates that customers are having difficulty with interoperability features of the product, it may be economical to expend engineering time and resources to improve those features.

The method illustrated in FIG. 7 represents one illustrative method for customer support data to quantify a product or system's consumability. Those of skill in the art will recognize that various steps of the illustrated example, could be combined, omitted, reordered or additional steps added to the process. By way of example and not limitation, the first mapping of data elements to market drivers/attributes (step 720) and the second mapping of attributes into consumability criteria (step 740) can be combined into a single step.

In sum, mapping aggregated customer support data into market drivers, consumability attributes, and consumability criteria provides multiple measures of a product's consumability. By identifying specific consumability attributes or criteria that need improvement, the organization can make the products easier for the customer to find, install, test and deploy to meet their business goals. Further, by relating support incident volumes to consumability characteristics, the cost of product flaws and weakness can be quantified.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for analyzing a product's consumability comprising:
gathering a plurality of customer service records, said customer service records containing customer service data;
mapping said customer service records into a plurality of consumability characteristics; and
generating a description of a distribution of said customer service records among said plurality of consumability characteristics.

2. The method of claim 1, wherein said customer service data is contained within a plurality of data fields.

3. The method of claim 2, wherein said data fields describe a customer's problem with said product, said data fields being ordered according to an exclusive problem classification taxonomy.

4. The method of claim 3, wherein said data fields comprise a number of predetermined entries, said predetermined entries being selected during an interaction between a customer and a customer service person.

5. The method of claim 1, wherein said consumability characteristics comprise market drivers, said market drivers defining portions of a customer experience associated with said product that impact on a market for said product.

6. The method of claim 5, wherein said market drivers are subdivided into consumability attributes, said consumability attributes describing a particular aspect of a consumer experience with said product for which consumability is being analyzed.

7. The method of claim 6, wherein said mapping comprises a first set of rules for classifying said customer service records into said consumability attributes.

8. The method of claim 7, wherein said first set of rules comprises an exclusive mapping such that a said customer service record is mapped to only one of said consumability attributes.

9. The method of claim 7, wherein said consumability attributes are subdivided into consumability criteria, said consumability criteria being correlated to stages within a lifecycle of said product.

10. The method of claim 9, wherein said mapping further comprises a second set of rules, said second set of rules mapping said consumability attributes into said consumability criteria.

11. The method of claim 10, wherein said second set of rules comprises an exclusive mapping such that each of said customer service records is mapped to only one of said consumability criteria.

12. The method of claim 10, wherein said second set of rules are a narrower subset of said first set of rules.

13. The method of claim 12, wherein at least one of said first mapping and said second mapping comprises weighting factors.

14. The method of claim 13, wherein said description is a visual display of a distribution of said customer service records among said consumability characteristics.

15. The method of claim 14, wherein said description of said distribution of said plurality of said customer support records is a graph representing a number of said customer support records within said consumability attributes or said consumability criteria.

16. The method of claim 15, further comprising using said description to identify potential targets for improvement in said product.

17. A computer program product for analyzing a product's consumability, the computer program product comprising:
a computer usable medium having computer usable program code embodied therewith, the computer usable program code comprising:
computer usable program code configured to aggregate customer service records, said customer service records containing customer service data, said customer service data containing a plurality of data fields, said plurality of data fields containing a selected entry from a predetermined set of entries, said selected entry being selected by a customer service person during an interaction between a customer and said customer service person;
computer usable program code configured to map said customer service records into a plurality of consumability characteristics including market drivers, consumability attributes and consumability criteria; said map being based on at least one sets of rules, said at least one sets of rules being applied to said selected entries within said plurality of data fields, said map categorizing each of said customer service records into a single consumability attribute and a single consumability criterion; and
computer usable program code configured to generate a description of a distribution of said customer service records among said plurality of consumability characteristics.

18. A system for analyzing consumability of a product comprising:
a collection of customer service records, said customer service records being related to a product;
a first mapping, said first mapping categorizing said customer service records into consumability attributes;
a second mapping, said second mapping categorizing said customer service records contained within each of said consumability into consumability criteria; and
a visual display, said visual display representing a description of a distribution of said customer support records within said consumability characteristics.

19. The system of claim 18, wherein said first mapping and said second mapping comprise exclusive mappings and are applied simultaneously.

20. The system of claim 19, wherein said second mapping comprises a narrower subset of said first mapping.
